(19) United States
(12) Patent Application Publication
(10) Pub. No.: US 2002/0057491 A1
(43) Pub. Date: May 16, 2002

(54) SEMI-CONDUCTOR OPTICAL AMPLIFIER WITH ADJUSTABLE STABLIZED GAIN AND AN OPTICAL SYSTEM USING SUCH AN AMPLIFIER

(76) Inventors: FRANCOIS DORGEUILLE, PARIS (FR); BRUNO LAVIGNE, ANTONY (FR); DOMINIQUE CHIARONI, ANTONY (FR); CHRISTOPHE OUGIER, PARIS (FR); JEAN-YVES EMERY, PALAISEAU (FR)

Correspondence Address: SUGHRUE MION ZINN MACPEAK & SEAS PLLC, 2100 PENNSYLVANIA AVENUE NW, WASHINGTON, DC, 200373213

(21) Appl. No.: 09/433,885

(22) Filed: Nov. 4, 1999

(30) Foreign Application Priority Data
Nov. 5, 1998 (FR) 9813949

(51) Int. Cl. H01S 3/00

(52) U.S. Cl. 359/344

(57) ABSTRACT

The invention relates to a semi-conductor optical amplifier comprising an active waveguide and a laser oscillator structure framing the active waveguide, characterized in that it includes at least one input for control of the gain at the threshold of the said laser structure to enable adjustment of the value of the amplifier's gain. This amplifier is intended to be used in an optical system which includes means of regulation capable of acting on the control inputs of the amplifier in response to the optical power of the carrier wave of an output signal to enable adjustment of the value of the amplifier's gain. This optical system makes it possible particularly to obtain power equalization of a signal at the entry to a telecommunication system.

The invention lies in the field of integrated photonic or optoelectronic devices usable especially for the transmission of digital data. It more particularly relates to a semi-conductor optical amplifier with adjustable stabilized gain intended for use in an optical system to achieve equalization of the levels of average power carried by the signals which pass through it.

Transmission lines today carry signals which are multiplexed in wavelength. In a telecommunication network there exist, in addition to the functions of transmission, the functions of routing, of configuration or reconfiguration to transport the information from a given entry point to a given exit point of the network. The signals do not all follow the same optical paths. In particular, they may be subject to differing attenuations. Consequently at the entry to an optical telecommunication system the signals do not necessarily all have the same power level.

In general, the functions of optical telecommunication systems depend on the conditions on entry, i.e. particularly on the power level of the signals on entry. This is because the output response of these systems can vary depending on the power levels of the signals on entry.

The aim of the invention is thus to produce an optical system the function of which is to equalize the power levels of the signals at the entry to a telecommunication system. The diagram of FIG. 1 permits clarification of the goal sought after. The optical system, reference 10, which it is sought to produce will allow the variations in power P entering another optical telecommunication system 1 to be eliminated. Furthermore, the function which it is sought to produce must be independent of the wavelength λ of the entering signal. The power Po at the exit from the optical system 10 will thus be constant whatever the power P of the entry signal and whatever the wavelength λ. Thanks to this optical system 10, the signal can thus attack the telecommunication system under the same conditions, i.e. with the same power level whatever the entry wavelength.

Solutions have already been envisaged in the prior state of the art to achieve this equalization of power. A first solution consists in using an optical fibre amplifier doped with Erbium, known in what follows as EDFA (“Erbium Doped Fiber Amplifier” in the Anglo-Saxon literature) at its saturation rating. For the frequency ranges used in telecommunication (greater than 100 MHz), the amplifier's gain remains stable when the signal passes from a high state to a low state. The EDFA thus reacts to the average power of the signal and it can be used at its saturation rating.

The EDFA is currently used for transmission in the window situated around a wavelength of 1.55 μm. When it is operating in its saturation rating, i.e. when the power level of the carrier wave of an input signal is greater than or equal to the saturation power of this amplifier, the power of the carrier wave of the output signal is constant.

In the case of signals λ₁ to λ_{N} multiplexed in wavelength, this amplifier will be sensitive only to the average total power of the signal received and not to the average power of each channel. Consequently it is necessary to de-multiplex the input signal and to use an EDFA to process each channel. Now such an amplifier is so expensive that it is not possible to envisage the use of an EDFA for each channel, because the price of the optical system would be considerably increased and would indeed become unacceptable. Furthermore, an EDFA cannot be incorporated on a microchip.

To resolve these two problems of cost and compactness, a second solution envisaged consists in using a semi-conductor optical amplifier, known in what follows as a “SOA” (“Semiconductor Optical Amplifier” in the Anglo-Saxon literature), operating at a linear rating. The classic “SOAs” have a high on-chip integration potential. At the amplifier's saturation rating the gain varies as a function of the binary data modulating the amplified signal, despite the high level of modulation generally used in the field of telecommunications. This non-linearity of gain brings about a reduction in contrast between the high level and the low level of the amplified signal. At this rating the SOA is sensitive to the instantaneous power of the signal. It therefore has to be used at its linear rating to avoid all deformation of the output signal. The power of the input signal carrier wave must therefore be very much lower than its saturation power.

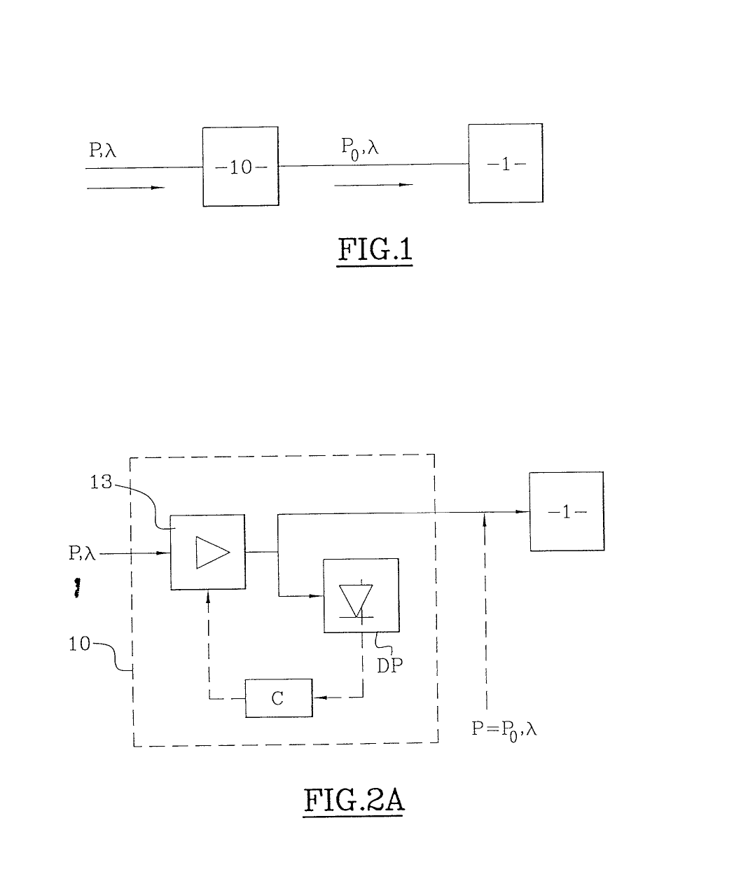

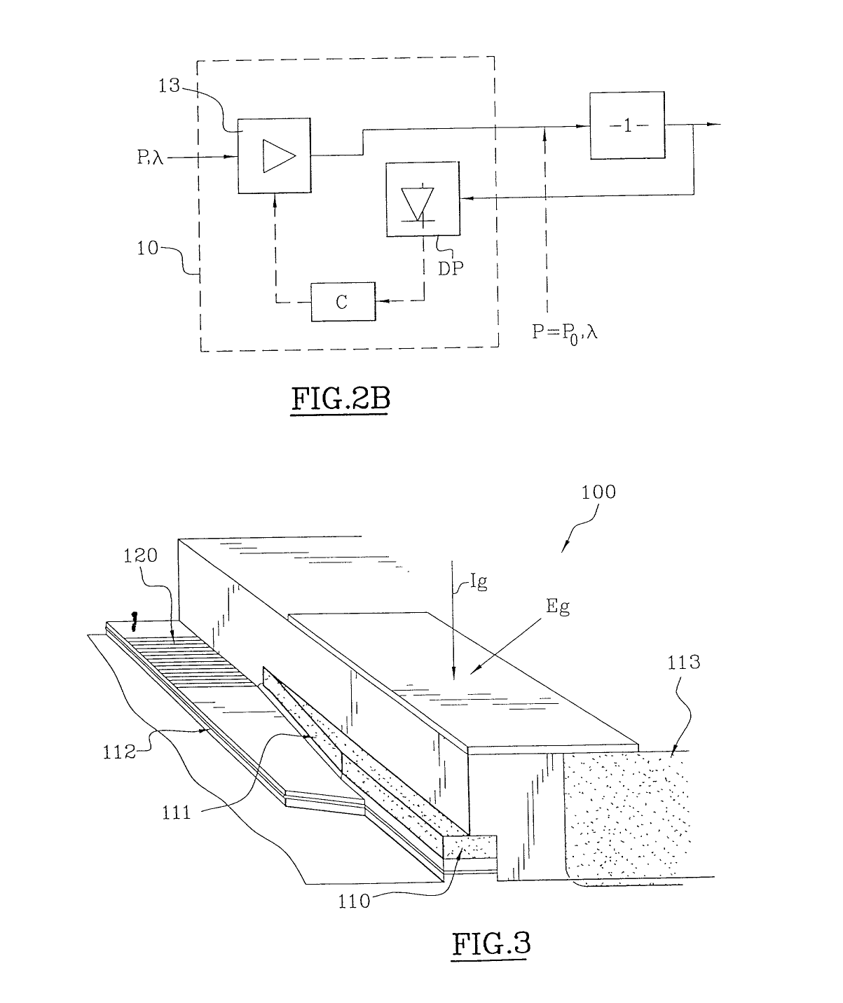

Furthermore to enable an equalization of power the amplifier's gain must be capable of being adjusted. For this the gain of the amplifier is thus dependently controlled by the output power. An embodiment of this dependent control is diagrammatically shown in FIG. 2A. A photodiode DP measures the power emitted by the carrier wave of the signal at the exit of the SOA 13, then an electronic processing circuit C compares the value of the measured power P with a reference power Po and triggers a control signal which acts on the amplification current of the SOA 13 and thus on its gain, in order to be able to equalize the measured value and the reference value. The electronic negative feedback thus makes it possible to control and adjust the amplifier's gain.

FIG. 2B describes a second embodiment of this dependent control. In this variant, the amplifier's gain is no longer dependently controlled by its exit power, but by the power detected at the exit from the telecommunications system 1.

The major drawback of this solution resides in the fact that the optical power available at the exit from device 10 remains small. The saturation power is defined as the value of the power which exists when the gain falls by half its value. Consequently the use of the SOA at its linear rating is very limited and the power P of the input signal must be very low to avoid exceeding the saturation power.

To remedy this drawback of low linearity and to increase the saturation power of the SOA, a solution consists in using a semi-conductor optical amplifier with stabilized gain, called GC-SOA in what follows (“Gain-Clamped Semiconductor Optical Amplifier” in the Anglo-Saxon literature).

FIG. 3 shows a perspective diagram showing an embodiment of a GC-SOA stabilized gain amplifier, stripped to show the layers in formation during manufacture. Since this amplifier is symmetrical, only one half is shown in the diagram. This amplifier includes an active waveguide 110 engraved in microstrip form and buried in a layer of sleeve locally implanted with protons 113. A mode adapter 111 is positioned at each end of the active waveguide 110. The active waveguide 110 is placed above a passive waveguide 112. The coupling between these two guides is therefore vertical and evanescent. Furthermore two Bragg reflectors 120, sampled or not, are placed on each side of the active guide 110, so as to create a laser cavity around the amplifying medium. An electrode Eg is also provided to enable the injection of an amplification current Ig, necessary to produce the gain in the amplifying medium.

To stabilize the gain of this GC-SOA amplifier the optical reaction produced by the Bragg reflectors at wavelength λ_{P} is used. The gain in the amplifying medium increases with the current Ig until it reaches a threshold value, for which laser oscillation takes place. Then, the operation is that of a laser oscillator. The operation of a laser oscillator is such that as long as you are above the threshold of this laser, the gain in the cavity remains constant. The amplifier's gain is thus stabilized. The laser oscillation takes place at a wavelength XB not used for the amplification of the input signal. This wavelength of oscillation λ_{B} is subsequently eliminated by filtering.

In another embodiment of this GC-SOA stabilized-gain amplifier, this optical reaction is obtained between a Bragg reflector, sampled or not, and a cleaved facet placed opposite the reflector.

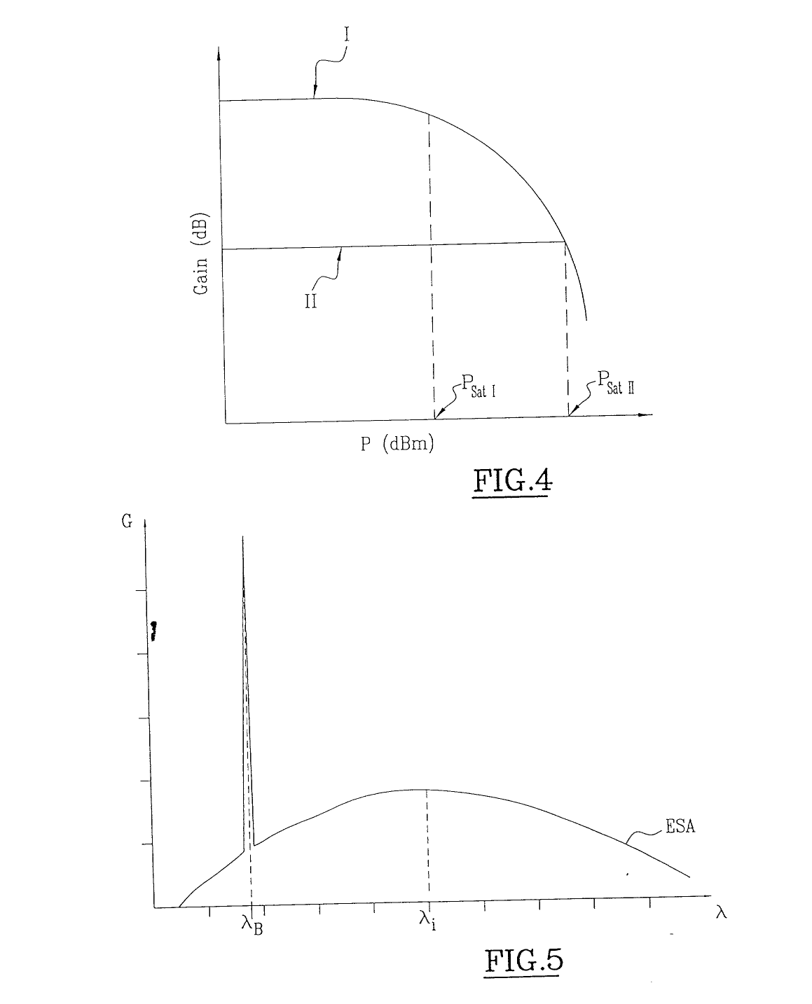

As soon as the threshold of laser oscillation is reached, the gain of the amplifier is fixed and stabilized. FIG. 4 shows two curves I and II of gain as a function of the power P of the output signal, respectively in a conventional SOA and in a stabilized-gain GC-SOA amplifier, for identical injected current. These two curves clearly show the increase in linearity of the optical response for a stabilized-gain amplifier. The saturation power P_{sat II} is thus increased by comparison with the saturation power P_{sat I} of a SOA.

However, a stabilized-gain amplifier does not make it possible to replace directly a classic SOA in the function of equalization of power as it is described in FIG. 2. This is because in this case, since the amplifier's gain is constant at output, it no longer depends on the amplification current 1g. The electronic feedback therefore no longer has any effect and no longer makes it possible to adjust the amplifier's gain. Consequently the output power of the amplifier follows the variations in input power. But as has been described above what is sought after is equalization of power so that the amplifier's output power shall be constant whatever the power level of the input signal.

The invention makes it possible to resolve the drawbacks of the previous state of the art. For this purpose it provides a semi-conductor optical amplifier with stabilized and adjustable gain. This amplifier has the advantage of having a relatively high saturation power, of being integrable, and of providing stabilized gain the value of which can be adjusted. This amplifier is also suitable for use in an optical system suitable for producing equalization of power.

The invention applies more particularly to a semi-conductor optical amplifier comprising an active waveguide and a laser oscillator structure framing the active waveguide, characterized in that it includes at least one gain control input at the threshold of the said laser structure to enable adjustment of the value of the amplifier's gain.

According to another characteristic of the invention, the control input(s) is/are constituted by at least one control electrode which is positioned above at least one section of the active waveguide.

According to another characteristic of the invention, the amplifier also comprises a passive waveguide, which is vertically coupled with the active waveguide, and the control input(s) is/are constituted by at least one electrode positioned above at least one section of the passive waveguide.

According to another characteristic of the invention, the control input(s) is/are constituted by two control electrodes which are positioned above two Bragg reflectors of the laser structure. These two control electrodes can also be connected together so as to simultaneously inject an identical current into each of these two reflectors.

According to another characteristic of the invention, the laser structure includes two reflectors, of which at least one is sampled, or has a phase-shift, and the control input(s) is/are constituted by at least one control electrode which is positioned above at least one reflector.

According to another characteristic of the invention, the laser structure includes only one Bragg reflector, sampled or not and the control input(s) is/are constituted by at least one control electrode which is positioned above the Bragg reflector.

Another object of the invention relates to an optical system comprising an amplifier capable of delivering an optical power of the carrier wave of an output signal which is constant whatever the power level of the input signal. The amplifier includes a laser structure for stabilization of gain and at least one gain control input, and the said optical system further includes means of adjustment the purpose of which is to act on the control inputs of the amplifier, in response to the optical power of the carrier wave of the output signal, to enable adjustment of the value of the amplifier's gain.

Thanks to the amplifier in accordance with the invention and to the optical system, power fluctuations of a signal can be eliminated. The amplifier according to the invention can be used in windows centred around any wavelength situated between 1.2 μm and 1.6 μm. It is simple, not costly, and integrable.

Other particular features and advantages of the invention will become evident upon reading the description given as an illustrative but not exhaustive example and given with reference to the appended figures, which show:

FIG. 1, described above, the schematic diagram of an optical system intended to equalize the power levels of a signal at the entry to a telecommunication system,

FIGS. 2A and 2B described above, two more detailed diagrams of two embodiments of an existing optical system, including a dependent control loop to provide power equalization,

FIG. 3, described above, a perspective view of a stabilized-gain amplifier stripped to show the layers in formation during manufacture,

FIG. 4, described above, two curves I and II of gain as a function of the output power, respectively of a conventional SOA amplifier and of a conventional GC-SOA stabilized-gain amplifier, for identical injected current,

FIG. 5, a curve of gain as a function of wavelength in a GC-SOA stabilized-gain amplifier,

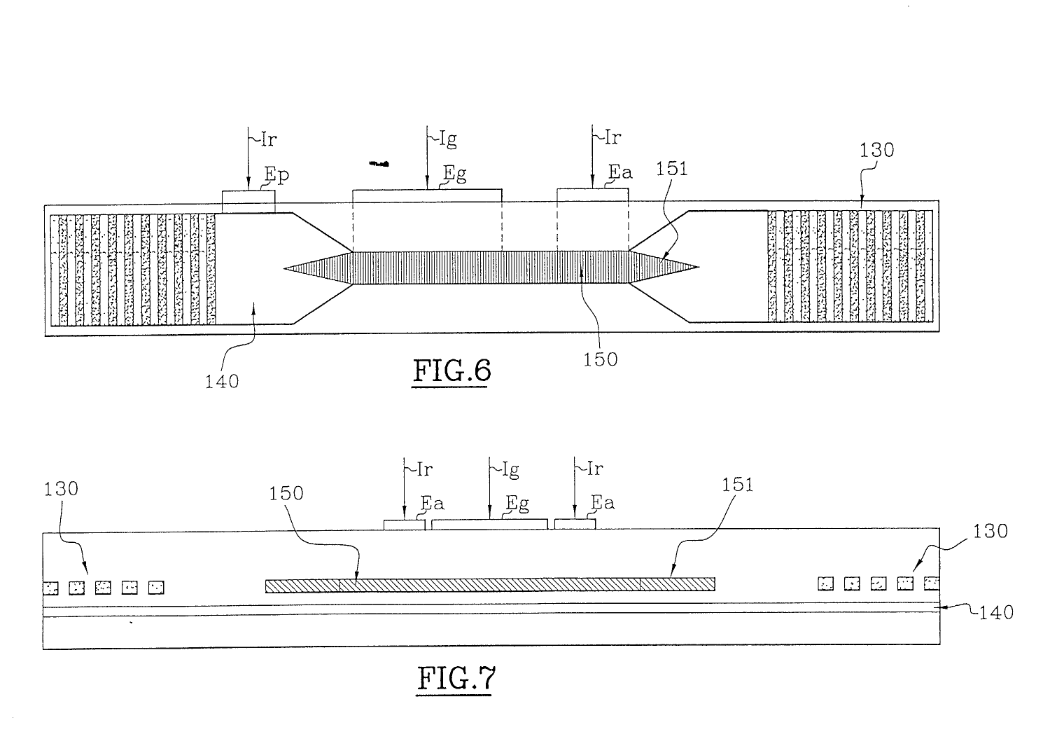

FIG. 6, a top view of an amplifier according to a first embodiment of the invention with a diagram of the position of the electrodes,

FIG. 7, a diagram in longitudinal section of another amplifier according to the first embodiment of the invention,

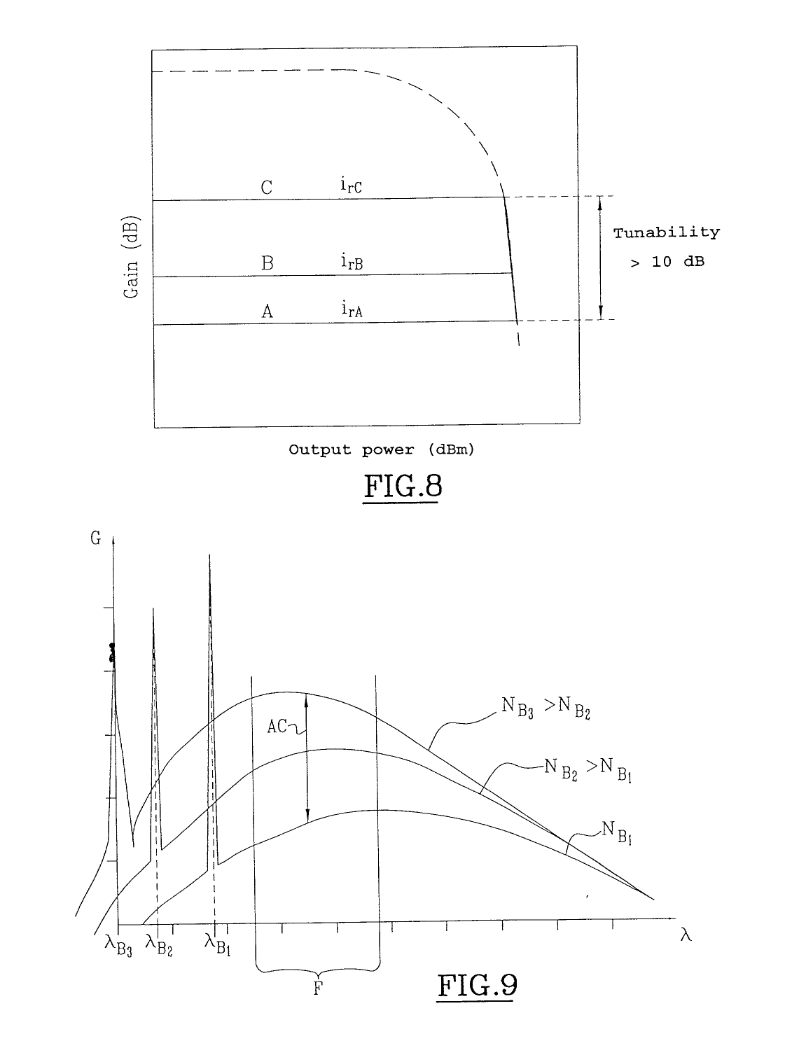

FIG. 8, curves A, B and C of the gain of the amplifier according to the invention as a function of the power of the output signal of the amplifier,

FIG. 9, gain curves as a function of the wavelength corresponding to an amplifier according to a second embodiment,

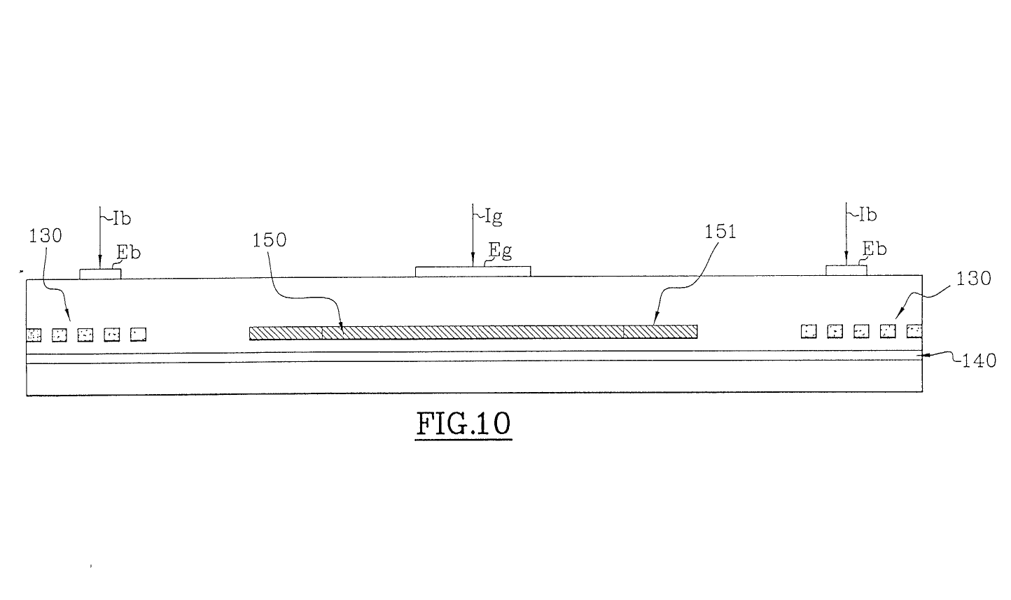

FIG. 10, a diagram of a longitudinal section view of an amplifier according to a second embodiment.

FIG. 5 shows the laser oscillation line emitted at wavelength λ_{B}, of the laser structure of the amplifier according to the invention, and the Amplified Spontaneous Emission (ASE) which is distributed over the whole pass-band of this amplifier. The amplification window must be centred around a wavelength λ, different from the wavelength λ_{B} of laser oscillation, to enable easy separation by filtering of the amplified signal from the laser oscillation.

For a laser cavity to be able to oscillate, the following condition must be fulfilled:

G(λ_{B})×a(λ_{B})×R(λ_{B})=1, where

G(λ_{B}) is the gain of the amplifying medium at the wavelength λ_{B} of laser oscillation,

a(λ_{B}) is the absorption losses of the laser cavity at wavelength λ_{B}, and

R(λ_{B}) is the loss in optical recharge of the laser cavity at wavelength λ_{B}. The value of the gain of the amplifying medium for which this relationship is true is the value which enables total losses in the laser cavity to be compensated. It is the gain at the threshold Gₜₕ(λ_{B}) of the laser.

The invention makes use of this condition and it is proposed to act on the gain at the threshold Gₜₕ(λ_{B}) of the laser cavity to cause it to vary and enable adjustment of the value of the amplifier's gain G(l).

Two preferred embodiments to produce a stabilized-gain amplifier are described in what follows. These two embodiments are based on the fact that the value of the gain at the threshold of the laser cavity can be modified by operating either on the properties of the amplifying medium or on the properties of the Bragg reflectors situated on either side of the amplifying medium and forming the laser cavity. These two effects may of course be combined.

FIGS. 6 and 7 show respectively a top view and a longitudinal section view of an amplifier according to a first embodiment of the invention. In FIG. 6 a diagram is also given of the positions of some electrodes with respect to the active and passive waveguides and to the Bragg reflectors of the amplifier.

Just as in a conventional stabilized-gain amplifier, the amplifier according to the invention includes an active waveguide 150 at the ends of which mode adapters 151 are provided. This active guide is vertically coupled with a passive guide 140. Two Bragg reflectors 130, sampled or not, are positioned on either side of the active guide 150, 151 to create a laser cavity.

In a variant of the embodiment, the laser cavity can also be created by a Bragg reflector, sampled or not, and a cleaved facet opposite the reflector.

The structure of this amplifier differs from that of conventional stabilized-gain amplifiers by the fact that it includes at least one control input enabling the gain at the threshold of the laser cavity to be acted on and caused to vary. This/these control input(s) is/are constituted by at least one extra electrode which is positioned above at least one section of one of the waveguides. Thus, for example, the amplifier includes at least one control electrode Ea positioned above at least one section of the active guide 150 (FIGS. 6 and 7) and/or at least one control electrode Ep positioned above at least one section of the passive guide 140 (FIG. 6).

The active waveguide 150, 151 of the amplifier is generally made of quaternary material. This material is absorbent for wavelengths such as λ<λg when no carrier is injected. λg is the forbidden bandwidth of the quaternary material, as expressed in the scale of wavelengths. Its attenuation decreases as the amplification current λg injected into the guide increases, i.e. as the density of the carriers increases. From a certain value of the injected current the guide becomes an amplifier and shows a gain. This property of the waveguide, which can be either absorbent or amplifying depending on operating conditions, is used in this first embodiment of the amplifier according to the invention.

In this case, it is considered that each section of waveguide which is covered by a control electrode Ea and/or Ep, is absorbent and shows attenuation. On the other hand, the other sections of the active waveguide constitute the amplifying medium of the component of the invention and thus show a gain G. It should be noted that the relationship fixing the conditions for laser oscillation is such that:

G(λ_{B})×a(λ_{B})×R(λ_{P})=1,

the wavelength λ_{B} of laser oscillation being fixed.

In order to be able to modify the properties of the laser cavity, and in particular its gain at the threshold Gₜₕ(λ_{B}), it is possible to cause variation in the losses a(λ_{B}) of the laser cavity by injecting one (or more) feedback currents I₁ on one (or more) control electrodes Ep and/or Ea. By modifying the gain at the threshold Gₜₕ(λ_{B}) of the laser cavity it is possible to tune the gain of the amplifying medium G(λ) to the wavelength λ of the signal. The tunability obtained, i.e. the range of adjustment, can be greater than 10 dB. This result is significant.

FIG. 8 illustrates three corresponding curves A, B and C of the stabilized and adjustable gain G of the amplifier as a function of the power of the carrier wave of the output signal. These curves confirm that whatever the input power, the gain G of the amplifier is stabilized and can be adjusted to different values by injecting a feedback current I, on at least one control electrode Ea and/or Ep.

In a variant of this embodiment, it is also possible to apply, on one or more control electrodes Ea and/or Ep, a reversely polarized voltage. In this case a section of guide is obtained which acts as an electro-absorbent modulator.

In another variant, it is also possible to apply simultaneously a current on one or more control electrodes, and a negative voltage on one or more other control electrodes, in order to modify the properties of the laser cavity.

According to a second embodiment of the invention, the coefficient of reflection R is acted on so as to modify the optical re-charging losses in the laser cavity. In this case, a number of variants are possible. In a fist variant, the laser structure includes two Bragg reflectors, at least one of which is sampled and well known to those skilled in the art. At lest one of these Bragg reflectors may also show a phase-shift; this is called a superstructure which is well known to those skilled in the art. In this variant, the amplifier includes at least one control input constituted by at least one control electrode which is positioned above at least one of the reflectors.

In a second variant, the laser structure includes a single Bragg reflector, sampled or not, positioned opposite a cleaved facet. In this variant the amplifier includes at least one control electrode which is positioned above the Bragg reflector.

In a third variant, the laser structure includes two non-sampled Bragg reflectors 130. This is the variant which is illustrated in the diagram of a longitudinal section in FIG. 10, in which the same references have been used to describe the same elements as in FIGS. 6 and 7. In this case the amplifier according to the invention includes two control electrodes Eb which are positioned above each Bragg reflector 130 of the laser cavity. The amplifiers according to the above three variants function identically. Only the number of control electrodes is subject to variation. This is the reason why only the functioning of the amplifier according to the third variant has been given in detail in what follows.

The injection of carriers into these reflectors by means of the control electrodes Eb makes it possible simultaneously to vary the absorption in the Bragg reflector, and thus its reflectivity, and to shift the Bragg wavelength λ_{B}. This result is diagrammatically represented in FIG. 9 which shows several curves of gain G of the amplifier as a function of wavelength X, depending on the density of the carriers N_{B1}, N_{B2} and N_{B3}, injected into the Bragg reflectors. As the current injected on the control electrodes Eb increases, i.e. as the density of the injected carriers increases, the Bragg wavelength shifts (λ_{B1}, λ_{B2} etc.). To maintain the condition of laser oscillation at the new Bragg wavelength λ_{B2}, the amplifier's gain curve is modified.

In another variant of embodiment, the two electrodes Eb can be joined, by a conducting wire or other means, in order to inject simultaneously an identical current into the two reflectors.

To shift the laser oscillation wavelength λ_{B} of the laser cavity, an injection of feedback current Ib is carried out on the control electrodes Eb. An injection of current on a single control electrode is sufficient in the case of amplifyers which comprise at least one sampled reflector. This injection of carriers makes it possible to modify the optical index in the Bragg reflectors. The modification of the optical index in a reflector is a way of varying its pitch and thus of modifying the characteristics of the laser cavity, particularly the gain at the threshold from which the laser cavity oscillates, and the laser oscillation wavelength.

By varying the wavelength λ of laser oscillation of the cavity, from λ_{B1} towards λ_{B3}, as shown in FIG. 9, a series of gain curves is obtained the intensity of which increases with the density of the injected carriers N_{B1}, N_{B2}, N_{B3}, (where N_{B1}>N_{B2}>N_{B1}). The tunability of the amplifier's gain in the spectrum window F, centred around 1.55 μm for instance, is diagrammatically represented by the double arrow AC in FIG. 9. The tunability obtained is significant; it can be greater than 10 dB.

In a variant of the embodiment, it is also possible to apply a negative voltage to the control electrode Eb. In this case an electro-refractive effect is obtained.

The invention also applies to an optical system intended to be placed at the entry to a telecommunication system, to equalize the power levels at the entry to this telecommunication system. The structure of the optical system according to the invention corresponds to the systems diagrams of FIGS. 2A and 2B since the same dependent control loop is used for a feedback to the amplifier. Only the amplifier used in the system according to the invention changes. This is because the optical amplifier used is the semi-conductor stabilized-gain amplifier according to the invention. A filter is also positioned at the exit from this amplifier to separate the oscillation wavelength λ_{B} from the amplified signal.

Just as in the prior state of the art, the dependent control loop comprises adjustment means. These adjustment means are constituted by a photodiode capable of measuring the power of the carrier wave of the signal at the exit of the amplifier (or, in a variant, at the exit of the telecommunication system), and by an electronic processing circuit. This circuit in turn includes on the one hand a comparator to compare the value of the measured power to a reference value, and on the other hand an interface which triggers a control signal which is applied to at least one control electrode of the amplifier to readjust the amplifier's level of gain so as to have a constant power level at the exit.

Thanks to the adjustable stabilized-gain amplifier according to the invention, it is possible to eliminate power fluctuations of a signal at the entry to a telecommunication system. The gain of the amplifier is adjustable over a range of more than 10 dB. The amplifier is used to obtain equalization of power in windows centred around any wavelength between 1.2 μm and 1.6 μm which are the wavelengths usually used in optical telecommunications. Furthermore, the amplifier according to the invention has the advantage of not being space-consuming because it is integrated on a chip.

1. A semi-conductor optical amplifier comprising an active waveguide (150) and a laser oscillator structure framing the active waveguide, characterized in that it includes at least one control input (Ea, Ep, Eb) for gain at the threshold of the said laser structure to enable adjustment of the value of the amplifier's gain.

2. An amplifier according to claim 1, characterized in that the control input(s) is/are consitituted of at least one control electrode (Ea) which is positioned above at least one section of the active waveguide (150).

3. An amplifier according to one of claims 1 to 2, characterized in that it further includes a passive waveguide (140) vertically coupled with the active waveguide (150), and in that the control input(s) is/are constituted by at least one control electrode (Ep) which is positioned above at least one section of the passive waveguide (140).

4. An amplifier according to claim 1, characterized in that the control input(s) is/are constituted by two control electrodes (Eb) which are positioned above two Bragg reflectors forming part of the laser structure.

5. An amplifier according to claim 4, characterized in that the two control electrodes (Eb) are connected so as to inject an identical current into each reflector.

6. An amplifier according to claim 1, characterized in that the laser structure includes two reflectors, at least one of which being sampled or showing a phase-shift, and the control input(s) is/are constituted of at least one control electrode which is positioned above at least one reflector.

7. An amplifier according to claim 1, characterized in that the laser structure includes a single Bragg reflector, sampled or not, and the control input(s) is/are constituted of at least one control electrode which is positioned above the Bragg reflector.

8. An optical system comprising a semi-conductor optical amplifier capable of delivering a constant optical power of the carrier wave of an output signal whatever the power (P) of an input signal, characterized in that the amplifier includes a laser oscillator structure for gain stailization and at least one input for control of gain at the threshold of the said laser structure, and in that the said transmission system also includes regulation means designed to act on the control inputs of the amplifier, in response to the optical power of the carrier wave of the output signal to enable adjustment of the value of the amplifier's gain.
